(19) United States
(12) Patent Application Publication
(10) Pub. No.: US 2026/0194041 A1
(43) Pub. Date: Jul. 9, 2026

(54) A WIND TURBINE GENERATOR COMPRISING AT LEAST ONE OSCILLATING DAMPING ARRANGEMENT

(71) Applicant: VESTAS WIND SYSTEMS A/S, Aarhus N (DK)

(72) Inventors: Kenji SATO, Yokohama (JP); Akihiro NAKAMURA, Yokohama (JP); Masayuki HIRAISHI, Yokohama (JP); Tooru MATSUO, Yokohama (JP)

(21) Appl. No.: 19/131,720

(22) PCT Filed: Nov. 27, 2023
(86) PCT No.: PCT/DK2023/050283

§ 371 Date: May 21, 2025

(30) Foreign Application Priority Data
Dec. 8, 2022 (DK) PA202270586

(51) Int. Cl. F03D 7/02; F03D 9/25; F03D 13/20; H02K 7/18; H02P 9/10; H02P 101/15

(52) U.S. Cl. CPC F03D 7/0298; F03D 9/255; F03D 13/201; H02K 7/1838; H02P 9/105; F05B 2240/912; H02P 2101/15

(57) ABSTRACT

A wind turbine generator is presented. The wind turbine generator comprises: —a support structure including a tower; —a nacelle connected to the tower; —two or more blades mounted on a hub connected to the nacelle; and—at least one oscillation damping arrangement arranged within at least one of the two or more blades, the at least one oscillation damping arrangement being tuned to one or more common frequencies of at least one coupled mode oscillation, such that the at least one coupled mode oscillation is mitigated by the at least one oscillation damping arrangement; wherein—the at least one coupled mode oscillation at the one or more common frequencies is a combination of oscillations of the support structure and oscillations of at least one of the two or more blades; and—the oscillations of the support structure and the oscillations of the at least one of the two or more blades are caused by forces transferred through the support structure at seismic activity in the ground where the support structure is positioned.

### TECHNICAL FIELD

Aspects of the present invention relate to a wind turbine generator comprising at least one oscillation damping arrangement within at least one of its blades, to a power plant comprising such wind turbine generators, to an oscillation damping arrangement, to a blade comprising at least one oscillation damping arrangement, to a method for mitigating at least one coupled mode oscillation of a wind turbine generator, and to a method for method for assembling a wind turbine generator.

### BACKGROUND

Undesired oscillations/vibrations may occur in wind turbine generators arranged for power generation due to, for example, the design of the wind turbine generators, current meteorological conditions and/or sudden seismic activity. Such oscillations may affect single parts of a wind turbine generator, or may affect the entire wind turbine generator.

The oscillations may cause dangerously high loads on parts of a wind turbine generator, which may lead to a sudden collapse, or may at least cause fatigue damages and possible lifetime reduction of the wind turbine generator and its components.

For example, cracks in a component of the wind turbine generator may grow more or less slowly due to such oscillations, until they ultimately lead to failure of the component. Oscillations therefore add an uncertainty factor to estimations of loads on, and wear of, various components of a wind turbine generator. Also, the oscillations cause an uncertainty related to an expected lifetime for components and/or wind turbine generators, possibly making it necessary to make the design stronger and heavier, and therefore more expensive, than would otherwise be the case.

Also, in extreme cases, severe oscillations may cause an immediate risk for damaged components and thus for the wind turbine generator to become inoperable.

### SUMMARY

Power plants including one or more wind turbine generators may be located in essentially any part of the world, both on land and at sea. In some geographical regions, the risk for seismic activity is higher than in other regions. For power plants located in regions with higher risk for seismic activity, there is naturally also an increased risk for oscillations in the wind turbine generators being caused by the seismic activity.

The seismic activity may, for example at earthquakes, cause forces around the foot/foundation of the tower of the wind turbine generator. These forces may be transferred through the support structure, including the tower, towards the nacelle, and further to the blades, and may cause harmful oscillations in both the support structure and in the blades.

Oscillations caused by seismic activity are, due to the sporadic nature of the seismic activity, very hard to predict when they will occur. The magnitude of the seismic activity, and also of the thereby created forces, are also very hard to predict, and may span from mild seismic activity, causing gentle forces and oscillations, to very severe seismic activity, causing component destroying forces and oscillations.

Thus, occasional and isolated seismic activity, for example in connection with earthquakes, may cause surprising and severe oscillations in wind turbine generators. Especially around the connection between the tower and the nacelle, severe and harmful loads may be created by such oscillations. These loads may cause damages to the wind turbine generator and its components, especially round the tower top and the nacelle.

An object of the present invention is to provide a solution which mitigates or solves the above mentioned problems related to wind turbine generator oscillations caused by seismic activity.

The above and further objects are solved by the subject matter of the aspects of the independent claims. Further advantageous embodiments of the invention can be found in the dependent claims.

According to a first aspect of the invention, a wind turbine generator is presented, the wind turbine generator comprising:
a support structure including a tower;
a nacelle connected to the tower;
two or more blades mounted on a hub connected to the nacelle; and
at least one oscillation damping arrangement arranged within at least one of the two or more blades, the at least one oscillation damping arrangement being tuned to one or more common frequencies of at least one coupled mode oscillation, such that the at least one coupled mode oscillation is mitigated by the at least one oscillation damping arrangement; wherein
the at least one coupled mode oscillation at the one or more common frequencies is a combination of oscillations of the support structure and oscillations of at least one of the two or more blades; and
the oscillations of the support structure and the oscillations of the at least one of the two or more blades are caused by forces transferred through the support structure at seismic activity in the ground where the support structure is positioned.

Thus, the at least one oscillation damping arrangement is, according to the present invention, arranged within at least one of the two or more blades, and is tuned to the one or more common frequencies of at least one coupled mode oscillation. To arrange the at least one oscillation damping arrangement within at least one blade provides for an efficient reduction of an experienced coupled mode oscillation. This is due to the fact that targeted coupled mode oscillations are influenced heavily by the motion of the blades, especially heavy blades of large size. Also, the combination of placing the at least one oscillation damping arrangement within at least one of the blades and also tuning it to one or more common frequencies of the coupled mode oscillations provides for a targeted damping effect precisely at the frequency where it has the most impact, i.e. at the frequency where the coupled mode oscillations due to the seismic activity has the highest amplitude.

Hereby, coupled mode oscillations caused by seismic activity are efficiently reduced by the at least one oscillation damping arrangement, which is especially adapted for mitigating the coupled mode oscillations at its one or more common frequencies. Thus, possibly surprising and severe coupled mode oscillations in wind turbine generators, especially around the connection between the tower and the nacelle, may be considerably reduced by the present invention. Thus, loads e.g. at the tower top due to the coupled mode oscillations is efficiently taken care of, such that the risk for wind turbine generator component damages and fatigue/wear is reduced.

This protection against severe coupled mode oscillations considerably reduces the load on the Rotor Nacelle Assembly (RNA) components. Hereby, the risk for violating an RNA type certification is reduced by utilization of the at least one oscillation damping arrangement according to the present invention, such that complicated design changes in the RNA structure may be avoided.

Generally, reductions of RNA component loads are otherwise very difficult to achieve on site for the specific power plants. Also, to change/re-issue the RNA type certification for a power plant due to its site specific conditions is a costly and time consuming process, which may be avoided when the aspects and embodiments of the present invention is utilized.

Due to the efficient protection against the coupled mode oscillations provided by the at least one oscillation damping arrangement, the wind turbine generator does not have to be otherwise designed for coping with extreme oscillations caused by seismic activity. Hereby, the total weight and total cost for the tower and the wind turbine generator may be reduced.

According to an embodiment of the present invention, the one or more common frequencies of the at least one coupled mode oscillation comprise a frequency within a range between first and second eigen frequencies of the support structure.

Due to the knowledge of the position/frequency of the at least one coupled mode oscillation, the at least one oscillation damping arrangement may be precisely tuned to that frequency for providing optimal impact/reduction on the coupled mode oscillations. Thus, the at least one oscillation damping arrangement may be controlled to protect the wind turbine generator against exactly those oscillations having the highest amplitude. Hereby, the most harmful oscillations are efficiently reduced.

According to an embodiment of the present invention, the at least one oscillation damping arrangement comprises a liquid damper including at least one liquid container.

Liquid dampers are low complexity and low-cost dampers providing, when arranged within the blades and tuned to the common frequencies according to various herein described embodiments, for an efficient reduction of the coupled mode oscillations caused by seismic activity.

According to an embodiment of the present invention, the liquid damper is tuned to the one or more common frequencies of the at least one coupled mode oscillation by controlling a level of liquid in the container.

Hereby, the liquid damper may be precisely adapted for efficiently mitigating the coupled mode oscillations at these frequencies.

According to an embodiment of the present invention, the at least one oscillation damping arrangement comprises at least one mass element, at least one spring element, and at least one damping element.

Such damping arrangements may be adapted for mitigating oscillations at specific frequencies, and are thus useful for efficiently reducing the coupled mode oscillations in the wind turbine generator. Also, a number of such damping arrangements, i.e. damping arrangements comprising mass, spring and damping elements, are available on the market. Thus, a low cost and off-the-shelf damping arrangement may be utilized, which lowers the production cost.

According to an embodiment of the present invention, the at least one oscillation damping arrangement comprises a friction spring damper.

The friction spring damper is a robust and efficient damper, which may easily be tuned to reduce oscillations at targeted frequencies, and which may be arranged with a blade of a wind turbine generator.

According to an embodiment of the present invention, the friction spring damper is tuned to the one or more common frequencies of the at least one coupled mode oscillation by adjustment of one or more in the group of:
a weight of the at least one mass element;
a spring constant of the at least one spring element; and
a damping effect of the least one damping element.

Hereby, one or more parameters of the friction spring damper may be adjusted to provide maximum reduction of the oscillations at precisely chosen frequencies.

According to an embodiment of the present invention, the at least one oscillation damping arrangement comprises a one or more in the group of:
at least one pendulum damper;
at least one eddy current damper; and
at least one hydraulic damper.

Thus, a number of different dampers may be utilized for the mitigation of the coupled mode oscillations, which provides for an increased implementation flexibility. Different dampers may be better in different implementations, and by the possibility to choose dampers from a set of dampers, an optimal damper for essentially each implementation may be found.

According to an embodiment of the present invention, the at least one oscillation damping arrangement is arranged closer to a tip of the blade than to a root of the blade.

To place the at least one oscillation damping arrangement towards the tip of the blade, in the outer half of the blade, results in a more efficient reduction of the oscillations, i.e. results in more efficient damping capabilities.

According to an embodiment of the present invention, the at least one oscillation damping arrangement is arranged in a direction within a blade such that edgewise vibrations of the blade are mitigated

Hereby, improved damping capabilities are provided for the at least one damping arrangement.

According to an embodiment of the present invention, the support structure comprises a monopile foundation.

Wind turbine generators comprising monopile foundations have been found particularly sensitive to seismic activity. To arrange at least one oscillation damping arrangement within at least one of the two or more blades of such a wind turbine generator therefore greatly reduces the risk for component damages and/or fatigue/wear in the wind turbine generator.

According to an embodiment of the present invention, the two or more blades have a length resulting in a rotor diameter of at least 150 m for the wind turbine generator.

Large wind turbine generators tend to experience higher seismic loads. To arrange the herein at least one oscillation damping arrangement within at least one of the two or more blades of such a large wind turbine generator reduces the risk for component damages and/or fatigue/wear, and also increases the expected component lifetime and reduces overall cost for the wind turbine generator.

According to an embodiment of the present invention, the wind turbine generator is an offshore wind turbine generator.

Many powerplants that experience seismic activity are located at sea. Due to restrictions related to construction and transportation of offshore wind turbine generators, the offshore wind turbine generators tend to be larger than their onshore counterparts. Larger wind turbine generators are generally more prone to seismic load. Thus, offshore wind turbine generators, that often also comprise a monopile foundation under water, are more often exposed to seismic loads, e.g. at earthquakes. To arrange the herein described at least one oscillation damping arrangement within at least one of the two or more blades considerably reduces the oscillation problems caused by seismic activities in such offshore wind turbine generators.

According to a second aspect of the invention, a power plant configured to provide electric power to an electric power grid is presented. The power plant comprises one or more of the herein disclosed wind turbine generators.

The above-mentioned efficient damping of coupled mode oscillations caused by seismic activity is hereby provided for one or more wind turbine generators in the power plant, which results in an overall reduced risk for component damages and/or fatigue/wear in the power plant.

According to a third aspect of the invention, an oscillation damping arrangement arranged within a blade of a wind turbine generator is presented. The wind turbine generator comprises:
a support structure including a tower;
a nacelle connected to the tower; and
two or more blades mounted on a hub connected to the nacelle; wherein:
the at least one oscillation damping arrangement is tuned to one or more common frequencies of at least one coupled mode oscillation, such that the at least one coupled mode oscillation is mitigated by the at least one oscillation damping arrangement;
the at least one coupled mode oscillation at the one or more common frequencies is a combination of oscillations of the support structure and oscillations of at least one of the two or more blades; and
the oscillations of the support structure and the oscillations of the at least one of the two or more blades are caused by forces transferred through the support structure at seismic activity in the ground where the support structure is positioned.

The oscillation damping arrangement arranged provides for an efficient damping of coupled mode oscillations. By being arranged within the blade, and by being tuned to the one or more common frequencies of at least one coupled mode oscillation, the coupled mode oscillations are specifically targeted and reduced by the oscillation damping arrangement, as explained above.

According to a fourth aspect of the invention, a blade of a wind turbine generator is presented. The wind turbine generator comprises:
a support structure including a tower;
a nacelle connected to the tower; and
two or more blades mounted on a hub connected to the nacelle;
the blade comprising:
at least one oscillation damping arrangement being tuned to one or more common frequencies of at least one coupled mode oscillation, such that the at least one coupled mode oscillation is mitigated by the at least one oscillation damping arrangement; wherein
the at least one coupled mode oscillation at the one or more common frequencies is a combination of oscillations of a support structure and oscillations of at least one of the two or more blades; and
the oscillations of the support structure and of the at least one of the two or more blades are caused by forces transferred through the support structure at seismic activity in the ground where the support structure is positioned.

By utilizing such a blade, i.e. a blade including at least one oscillation damping arrangement being tuned to the one or more common frequencies of at least one coupled mode oscillation, in a wind turbine generator, an efficient protection against harmful coupled mode oscillations is provided, as explained above. Due to the large size and high weight of the wind turbine generator blades today, targeted coupled mode oscillations are influenced heavily by the motion of the blades. Therefore, the experienced coupled mode oscillation can be effectively reduced by locating at least one damping arrangement inside one or more blades.

According to a fifth aspect of the invention, a method for mitigating at least one coupled mode oscillation of a wind turbine generator is presented. The wind turbine generator comprises:
a support structure including a tower;
a nacelle connected to the tower;
two or more blades mounted on a hub connected to the nacelle; and
at least one oscillation damping arrangement arranged within at least one of the two or more blades;
the method comprising:
determining one or more common frequencies of at least one coupled mode oscillation being a combination of oscillations of the support structure and oscillations of at least one of the two or more blades, wherein the oscillations are caused by forces transferred through the support structure at seismic activity in the ground where the support structure is positioned; and
tuning the at least one oscillation damping arrangement to the determined one or more common frequencies.

The presented method may be utilized for providing an efficient protection against harmful coupled mode oscillations at seismic activity, as explained above.

According to a sixth aspect of the invention, a method for assembling a wind turbine generator is presented. The method comprises the steps of:
erecting a support structure including a tower;
connecting a nacelle to the tower;
mounting two or more blades on a hub connected to the nacelle;
determining one or more common frequencies of at least one coupled mode oscillation being a combination of oscillations of the support structure and oscillations of at least one of the two or more blades, wherein the oscillations are caused by forces transferred through the support structure at seismic activity in the ground where the support structure is positioned;
arranging at least one oscillation damping arrangement within at least one of the two or more blades; and
tuning the at least one oscillation damping arrangement to the determined one or more common frequencies.

The presented method may be utilized for assembly of a wind turbine generator such that it has an efficient protection against coupled mode oscillations at seismic activity, as explained above.

The oscillation damping arrangement of the third aspect, the blade of the fourth aspect, and the methods of the second to sixth aspects, respectively, have, in addition to what is mentioned above, corresponding advantages as the ones mentioned above for the wind turbine generator according to the first aspect of the invention and its embodiments.

Further advantageous embodiments of the wind turbine generator, the power plant, the oscillator damping arrangement, the blade, the method for mitigating at least one coupled mode oscillation, and the method for assembling a wind turbine generator according to the present invention, and further advantages of the embodiments of the present invention, emerge from the detailed description of embodiments.

### BRIEF DESCRIPTION OF THE DRAWINGS

Aspects and embodiments of the invention are illustrated, for exemplary purposes, in more detail by way of embodiments and with reference to the enclosed drawings, where similar references are used for similar parts, in which:

FIG. 1 is a schematic diagram illustrating an example of a power plant, in which aspects and embodiments of the present invention may be implemented;

FIG. 2 is a schematic diagram illustrating a wind turbine generator, in which aspects and embodiments of the present invention may be implemented;

FIG. 3 shows and example frequency spectrum momentum chart schematically illustrating coupled mode oscillations;

FIGS. 4a-b are schematic diagrams illustrating examples of oscillation damping arrangements in a blade according to various embodiments of the present invention;

FIG. 5 is a flow chart diagram for a method according to an aspect of the present invention;

FIG. 6 is a flow chart diagram for a method according to an aspect of the present invention; and

FIG. 7 is a frequency spectrum showing the impact of the present invention on a tower load.

### DETAILED DESCRIPTION

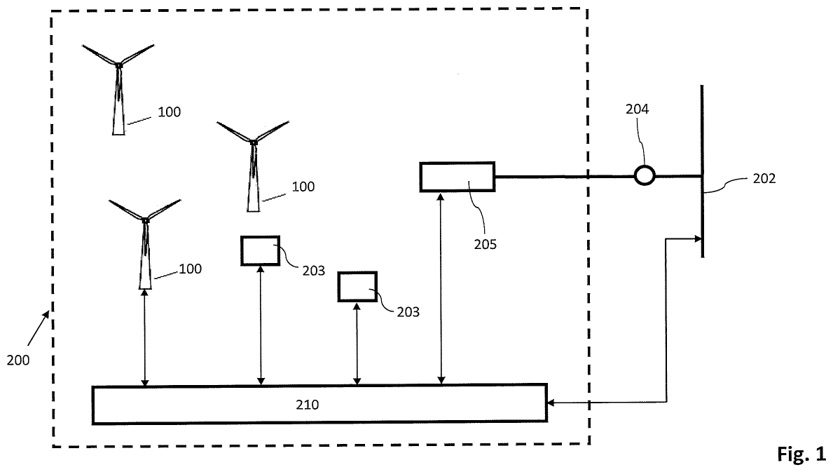

FIG. 1 schematically illustrates a non-limiting example of a power plant 200, in which aspects and embodiments of the present invention may be implemented. The aspects and embodiments of the present invention may, of course be implemented in any essentially solution, in which one or more wind turbine generators 100 are used, and is not limited to implementation in the power plant example in FIG. 1, or in power plants as such.

The power plant 200 is arranged for providing electric power, or electrical energy, to an electric power grid 202. The power plant 100 includes one or more electric power generating units, such as wind turbine generators 100. According to some embodiments, the power plant 200 may also include one or more other electric power generating units 203, such as e.g. photo-voltaic panels, and fuel cells. The wind turbine generators, the photo-voltaic panels, and the fuel cells may also be generally described as power sources of the power plant 200, or as power generators of the power plant 200. The power plant 200 may also include an energy storage system 205.

The power plant 200 may be connected, or connectable, to the electric power grid 202 via a point of common coupling (PCC) 204. For some embodiments, the electric power grid 202 may be referred to as a utility grid, an electrical grid, or an electric power network. For example, the power plant 200 may be located offshore or on land.

The power plant 200 may include a control arrangement 210 configured to control the power plant 200. According to some embodiments, the control arrangement 210 may comprise, or be referred to as, a power plant controller (PPC). As schematically illustrated in FIG. 1, the power plant controller 210 controls the power generating units 100, 203 and the energy storage system 205.

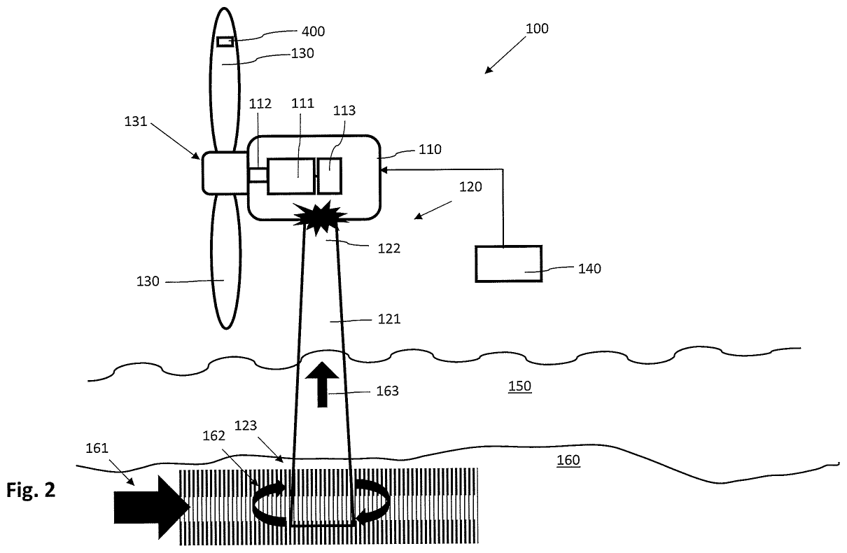

FIG. 2 schematically illustrates an example of the wind turbine generator 100 of the power plant 200 of FIG. 1, in which the herein presented aspects and embodiments may be implemented. The wind turbine generator 100 may comprise a rotor 131 including two or more blades 130, such as for example three blades, or more, attached to a rotor 131. The wind turbine generator 100 comprises a support structure 120 including a tower 121 and a foundation 123. The wind turbine generator 100 also includes a nacelle 110 mounted/connected to the top of the tower 122. The rotor 131 may be connected, such as rotatably connected or mounted, to the nacelle 110. The wind turbine generator 100 may comprise an electric generator 111 to which the rotor 131 is connected. The rotor 131 is configured to drive the electric generator 111. The nacelle 124 may house the electric generator 111.

The rotor 131 is rotatable by action of the wind. The wind-induced rotational energy of the two or more blades 130 and rotor 131 may be transferred via a coupling 112, for example including one or more shafts, to the electric generator 111. Thus, the wind turbine generator 100 may be described as being configured to convert kinetic energy of the wind to mechanical energy, or rotational energy, by way of the two or more blades 130 and, subsequently, to electric power by way of the electric generator 111. The wind turbine generator 110 may comprise one or more power converters 113 connected to the electric generator 111. The wind turbine generator 100 and/or the electric generator 111 may be connected to the electric power grid 102 via the one or more power converters 113. The one or more power converters 113 may comprise a first power converter for converting AC power from the electric generator 111 to DC power. The one or more power converters 113 may comprise a second power converter for converting DC power from the first power converter to AC power to be provided to the electric power grid 102. The nacelle 110 may house the one or more power converters 113, or the one or more power converters 113 may be located elsewhere.

With reference to FIG. 2, the wind turbine generator 100 may comprises a control arrangement 140 for controlling the wind turbine generator 100. The control arrangement 140 of the wind turbine generator 100 may be configured to communicate with and/or be connected to, or be part of, the control arrangement 210 of the power plant 200.

As schematically illustrated in FIG. 2, the wind turbine generator 100 may, for example, be an offshore wind turbine generator, where the tower 121 is located at sea in water 150. The wind turbine generator 100 may be positioned such that its tower 121 is mounted on a foot/foundation 123 in or on the ground 160. In some parts of the world, seismic activity 161 in the ground 160 sometimes occur. The seismic activity 161 then causes forces 162 around the foot/foundation 123 of the tower 121. These forces 162 due to the seismic activity 161 in the ground also creates forces 163 being transferred through the tower towards the nacelle 110. Thus, forces originating from seismic activity 161 in the ground where the wind turbine generator 100 is located may be transferred to the support structure 120. These forces may then travel through the support structure 120 towards the nacelle 110, the rotor 131, and finally towards the two or more blades 130.

These forces 163 travelling through the support structure 120 and towards the tower top 122 and the two or more blades 130 may cause oscillations in both the support structure 120 and in the two or more blades 130. These oscillations may cause considerable loads in the wind turbine generator 100, and may e.g. cause severe damages at the tower top 122, as schematically illustrated in FIG. 2.

Of course, although FIG. 2 schematically illustrates an offshore wind turbine generator, corresponding forces originating from seismic activity 161 may also occur in onshore wind turbine generators, i.e. in wind turbine generators located on land where seismic activity occurs.

According to an aspect of the present invention, a wind turbine generator 100 is presented. The wind turbine generator 100 comprises, as mentioned above, a support structure 120 including a tower 121, and a nacelle 110 connected to the tower 121. The wind turbine generator 100 further comprises two or more blades 130 mounted on a hub 131 connected to the nacelle 110.

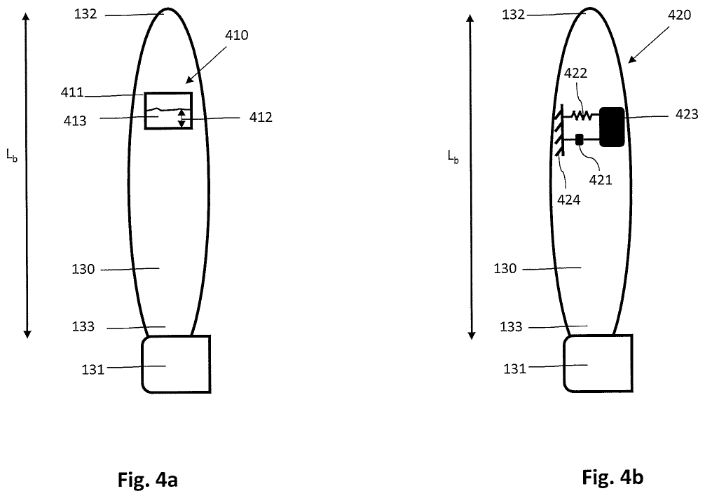

The wind turbine generator 100 comprises at least one oscillation damping arrangement 400, schematically illustrated in FIG. 2 and described more in detail below in connection with FIGS. 4a-b, which is arranged within at least one of the two or more blades 130. The at least one oscillation damping arrangement 400 is especially arranged for damping coupled mode oscillations in the wind turbine generator 100 caused by seismic activity.

As mentioned above, seismic activity 161 in the ground 160 where the support structure 120 is positioned creates forces 163 that may travel through the support structure 120. These forces may cause oscillations of the support structure 120 and may cause oscillations of the at least one of the two or more blades 130. The combined oscillations of the support structure 120 and of the at least one of the two or more blades 130 have by the inventors been found to cause at least one coupled mode oscillation at one or more common frequencies f_{common}, as explained more in detail below.

According to the embodiment of the present invention, the at least one oscillation damping arrangement 400, which is arranged within at least one of the blades 130, is tuned to the one or more common frequencies f_{common} of the at least one coupled mode oscillation. Hereby, the at least one coupled mode oscillation is efficiently mitigated/reduced by the at least one oscillation damping arrangement 400 mounted within at least one blade 130, as schematically illustrated in FIG. 2.

Generally, the support structure 120 has its own oscillation/vibration modes at unique eigen/natural frequencies f_{structure} of the support structure 120. Correspondingly, the two or more blades 130 have their own oscillation/vibration modes at other unique eigen/natural frequencies f_{blade} of the blades. As is well known by a skilled person, eigen/natural frequencies are certain discrete frequencies at which each specific component/device/system is more prone to oscillate/vibrate compared to other frequencies. An eigen/natural frequency of a component/device/system is in other words a frequency at which the component/device/system tends to oscillate in absence of any driving force. Thus, the support structure 120 has one set of eigen/natural frequencies f_{structure}, and the blades 130 have another set of eigen/natural frequencies f_{blade}, where these sets of eigen/natural frequencies differ; f_{structure}≠f_{blade}.

The inventors of the herein presented wind turbine generator 100 and of the at least one oscillation damping arrangement 400 have found that, when the forces caused by the seismic activity travel through the support structure 120 towards the nacelle 110 at seismic activity, the oscillation modes of the support structure 120 and the oscillation modes of the two or more blades 130 are coupled/combined such that new oscillation/vibration modes appear. Thus, the oscillation modes of the support structure 120 and the oscillation modes of the two or more blades 130 hereby interact with each other such that new coupled oscillation/vibration modes are created. The present invention utilizes that these new coupled oscillation modes occur at new eigen frequencies f_{common}, being different from the eigen frequencies of the support structure and the blades, respectively; f_{common}≠f_{structure} and f_{common}≠f_{blade}. These new eigen frequencies f_{common} of the coupled oscillation modes are in this document called one or more common frequencies f_{common}, which indicates that these frequencies are coupled/resulting/combined frequencies being caused during seismic activity as a result of a combination/interaction of the oscillations of the support structure 120 at its one or more support eigen frequencies f_{structure} and of oscillations of the at least one blade 130 at its one or more blade eigen frequencies f_{blade}.

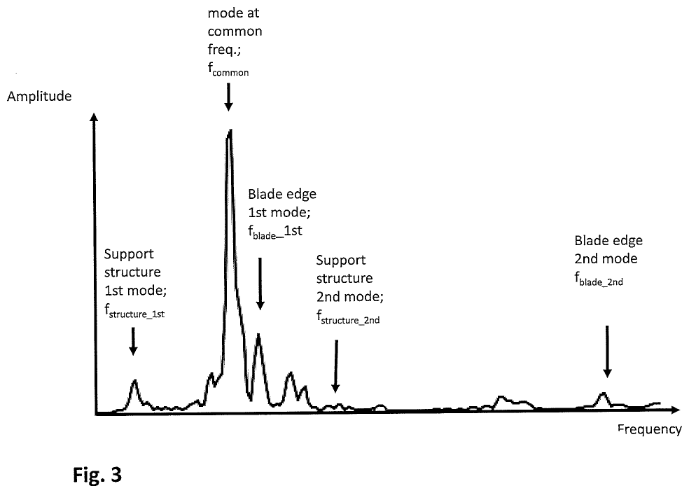

FIG. 3 schematically illustrates a non-limiting example of a frequency spectrum chart for a moment amplitude, in which the eigen frequencies of the support structure f_{structure} and of the blades f_{blade}, and also the eigen frequencies of the coupled mode oscillations f_{common}, are indicated. The example frequency spectrum chart in FIG. 3 is shown to explain the principles of the herein presented solution, but is not limiting for the herein described solution.

In the illustrated example of FIG. 3, the first mode momentum at the first eigen/natural frequency (Support structure 1^{st} mode; f_{structure_1st}) and the second mode momentum at the second eigen/natural frequency (Support structure 2^{nd} mode; f_{structure_2nd}) of the support structure are shown. Also, the first mode momentum at the first eigen/natural frequency (Blade edge 1^{st} mode; f_{blade_1st}) and the second mode momentum at the second eigen/natural frequency (Blade edge 2^{nd} mode; f_{blade_2nd}) of the blade are shown.

Further, the momentum of the coupled mode oscillation/vibration (Coupled mode at common freq.; f_{common}) is also illustrated in the example frequency spectrum chart in FIG. 3. As shown in the figure, the momentum of the coupled mode oscillation is much greater, i.e. has a higher amplitude, than the momentum at the eigen frequencies of the support structure f_{structure} and of the blades f_{blade}, respectively. The coupled mode oscillation/vibration occurs at one or more common/coupled frequencies f_{cmmon}, being different from the eigen frequencies of the support structure and the blades; f_{common}≠f_{structure} and f_{common}≠f_{blade}, as mentioned above.

Thus, during earthquakes and other seismic activities, severe loads may be applied e.g. at the tower top, such as at the nacelle, due to coupled mode oscillations at these one or more common frequencies f_{common}, being other/separate from the eigen/lateral frequencies of both the support structure and the blades; f_{common}≠f_{structure} and f_{common}≠f_{blade}.

Thus, for the non-limiting example illustrated in FIG. 3, the at least one oscillation damping arrangement 400 according to various embodiments of the present invention, should be arranged within at least one of the blades 130 of the wind turbine generator 100 and should be tuned to the high amplitude oscillation at the common frequency f_{common}.

Since the at least one oscillation damping arrangement, according to various embodiments of the present invention, is tuned to the common frequency f_{common} of at least one coupled mode oscillation, the damping effect of the at least one oscillation damping arrangement 400 may be targeted to the frequency where it has the most impact. i.e. where the oscillation its highest amplitude. Hereby, the at least one oscillation damping arrangement is especially adapted to efficiently mitigate the at least one coupled mode oscillation, such that the risk for wind turbine generator component damages and fatigue/wear is reduced.

The inventors of the herein described oscillation damping arrangement and wind turbine generator have found that at least one oscillation damping arrangement arranged within at least one of the two or more blades 130, which is properly tuned to the one or more common frequencies f_{common} of at least one coupled mode oscillation, efficiently damps the momentum of the coupled mode oscillations. Hereby, the load e.g. at the tower top 122 due to the coupled mode oscillations is efficiently reduced.

According to an embodiment, the at least one oscillation damping arrangement 400, which is arranged within at least one of the two or more blades 130, as schematically illustrated in FIG. 2, is tuned to the at least one coupled mode oscillation having a frequency within a range between first f_{structure_1st} and the second f_{structure_2nd} eigen frequencies of the support structure 120.

The inventors have found that one of the common frequencies f_{common} is located in the frequency range between the first f_{structure_1st} and second f_{structure_2nd} eigen/natural frequencies of the support structure. Thus, to tune/calibrate the at least one oscillation damping arrangement 400 to a value within this frequency range efficiently reduces the coupled mode oscillations.

Thus, the one or more common frequencies f_{common} may be determined based on the the first f_{structure_1st} and the second f_{structure_2nd} eigen frequencies of the support structure 120. According to various embodiments, the first f_{structure_1st} and the second f_{structure_2nd} eigen frequencies of the support structure 120 may be derived by numerical analysis, e.g. specific eigen-value analysis, during the design process of the support structure.

Generally, it may not be feasible to perform frequency measurements related to the coupled mode oscillation frequencies at site. Therefore, the eigen-value frequencies of the support structure f_{structure} and/or the blade f_{blade} may be determined by numerical eigen-value analysis, which may include e.g. frequency analysis using a time-domain method, when the support structure 120 and/or blades 130 are designed, respectively. The results of this eigen-value analysis may then possibly be verified during commissioning of the wind turbine generator 100.

Based on the hereby determined first f_{structure_1st} and the second f_{structure_2nd} eigen frequencies of the support structure, the common frequencies f_{common} of the at least one coupled mode oscillation are then determined, as explained above, and the at least one oscillation damping arrangement 400 is tuned/calibrated to the hereby determined common frequencies f_{common}.

For example, as schematically illustrated in the non-limiting example of FIG. 3, the coupled mode oscillation/vibration may occur at a common frequency f_{common} essentially in the middle between the first f_{structure_1st} and second f_{structure_2nd} eigen/natural frequencies of the support structure, i.e. essentially in the middle of the frequency range between the first f_{structure_1st} and second f_{structure_2nd} eigen/natural frequencies of the support structure. The at least one oscillation damping arrangement 400 should then be tuned to this specific frequency to efficiently reduce these coupled mode oscillations.

An oscillation damping arrangement 400 being tuned or calibrated to a specific frequency means in this document that the damping effect of the oscillation damping arrangement 400 is highest for this specific frequency. Thus, when the oscillation damping arrangement 400 is tuned to a common frequency f_{common}, then the oscillation damping arrangement 400 is set/arranged for considerably damping/mitigating the coupled mode oscillations at this common frequency f_{common}. Oscillations in frequencies other than the common frequency f_{common} will then be less damped/mitigated than the coupled mode oscillations at this common frequency f_{common} will be damped. In other words, when the oscillation damping arrangement 400 is tuned to a common frequency f_{common}, it is adapted for performing a targeted considerable reduction of the coupled mode oscillations at that common frequency f_{common}.

The herein presented wind turbine generator 100 and/or at least one oscillation damping arrangement 400 may especially be utilized for geographical locations and/or implementations where oscillations/vibrations due to seismic activity is likely to affect the wind turbine generator 100. For example, support structures 120 comprising monopile foundations are, due to its structural nature, found to generally be more likely to suffer from severe tower top problems caused by seismic activity than support structures comprising jacket foundations are. This is due to the features of the monopile construction, where momentum loads from seismic activity may be transferred to the tower top through directly connected piles. Also, monopile foundations are often utilized for offshore implementation/localization of wind turbine generators. Further, many of the power plants experiencing, and being affected by, seismic activity are localized offshore, i.e. at sea, and are typically equipped with monopile foundations under water.

The herein presented solutions for mitigating coupled mode oscillations may therefore, according to various embodiments, be utilized for efficiently reducing the coupled oscillations for wind turbine generators 100 comprising monopile foundations and/or being located offshore.

Further, the herein presented solutions may, according to some embodiments, be utilized for wind turbine generators having long/large blades, for example blades 130 having a length L_{b} resulting in a rotor diameter Dᵣₒₜₒᵣ of at least 150 m; Dᵣₒₜₒᵣ≥150 m; for the wind turbine generator 100. The inventors have found that wind turbine generators having such large rotor diameters Dᵣₒₜₒᵣ are sensitive for seismic activity, and are especially important to protect, as herein described.

According to an embodiment schematically illustrated in FIG. 4a, the at least one oscillation damping arrangement 400 comprises a liquid damper 410 including at least one container 411 containing a liquid. The liquid damper is a passive damper utilizing the inertia of the liquid floating around in the container 411 to reduce the coupled mode oscillations.

The container 411 of a liquid damper may, according to various embodiments, have various shapes/forms/configurations/designs. For example, the container 411 may be box-shaped, i.e. may have an essentially rectangular cross section with at least partially straight walls. The container 411 may also have curved walls, such that it, for example, has a U-formed or a O-formed cross section.

A liquid damper 410 having a box-shaped container 411 may, according to an embodiment, be tuned to the one or more common frequencies f_{common} of the at least one coupled mode oscillation by controlling a level of liquid H/412 in the container 411.

The container 411 may, for example, have a width, a height, and a length L that fulfil certain criteria in relation to each other, and/or to the liquid level H_{I}, such that the damping properties for the liquid damper 410 are optimized.

More in detail, the liquid damper 410 may be tuned to a damping frequency f_{d} by adjusting the liquid level H_{I} according to this equation:

$${f}_{d} = \frac{1}{2 * π} \sqrt{\frac{π * g}{L} tan ( \frac{π * {H}_{l}}{L} )} \qquad ( eq . 1 )$$

Where:
f_{d} is the damper frequency;
g is the acceleration of gravity;
L is the length of the container; and
H_{I} is the liquid level.

Thus, if the liquid damper 410 is tuned, by adjustment of the liquid level H_{I}, such that its damper frequency corresponds to the one or more common frequencies f_{common}, then the coupled mode oscillations occurring at these one or more common frequencies f_{common} are efficiently mitigated by the liquid damper.

According to an embodiment, the liquid damper 410 is arranged closer to a tip 132 of the blade than to a root 133 of the blade. Thus, the liquid damper 410 is mounted at the outer half of the blade 130, towards the tip 132, i.e. at a 50-100% spanwise position, and according to an embodiment preferrable as far out on the blade 130 as possible, which improves its oscillation damping properties. Also, the liquid damper may, according to an embodiment, be arranged in a direction within the blade 130 such that edgewise vibrations of the blade 130 are mitigated.

According to an embodiment, the at least one oscillation damping arrangement 400 comprises at least one mass element 423, at least one spring element 422 and at least one damping element 421.

One such oscillation damping arrangement, schematically illustrated in FIG. 4b, is a friction spring damper 420 including a mass element 423 attached to at least one fixed component 424 of the blade via at least one spring element 422 and at least one damping element 421. For example, the at least one spring element 422 and the at least one damping element 421 may be arranged in parallel between the fixed component 424 and the mass element 423. The at least one fixed component 424 may be essentially any fastened interior part of the blade, such as e.g. an inner casing/housing of the blade 130 or any other part of the internal construction of the blade 130.

In order to efficiently reduce the coupled mode oscillations, the friction spring damper 420 is tuned to the one or more common frequencies f_{common} of the at least one coupled mode oscillation. This tuning may be performed by adjustment of the weight of the mass element 423, by adjustment of a spring constant of the at least one spring element 422 and/or by adjustment of the damping effect of the at least one damping element 421 such that the damping frequency f_{d} of the friction spring damper corresponds to the common frequency f_{common}.

According to an embodiment, the at least one oscillation damping arrangement 400 is arranged within the blade 130, closer to the tip 132 of the blade than to the root 133 of the blade, e.g. as far out on the blade 130 as possible, which improves its oscillation damping properties. The at least one oscillation damping arrangement 400 may also, according to an embodiment, be arranged in a direction reducing edgewise vibrations of the blade 130.

According to various embodiments, the at least one oscillation damping arrangement 400 may comprise at least one pendulum damper, at least one eddy current damper, and/or at least one hydraulic damper.

Generally, essentially any suitable oscillation damping arrangement 400, which is suitable for being arranged within a blade 130 of wind turbine generator 100 and which is possible to tune to the common frequency f_{common} of the coupled mode oscillations may be utilized as a damper according to various embodiments of the present invention. For most of these oscillation damping arrangements 400, their damping properties for the coupled mode oscillations are improved if they are arranged along the outer half of the length L_{b} of the blade 130 and/or if they are arranged in a direction in relation to the blade edges which reduces edgewise vibrations of the blade 130.

According to an aspect of the present invention, a method 500 for mitigating at least one coupled mode oscillation of a wind turbine generator 100 is presented.

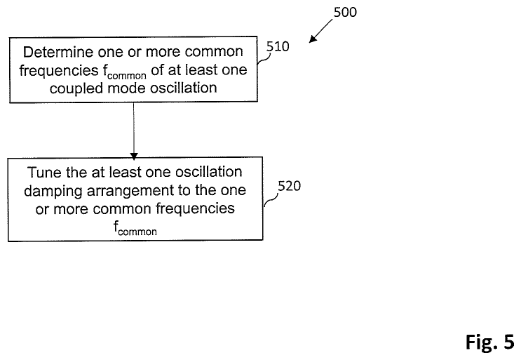

FIG. 5 shows a flow chart diagram for the method 500.

The method is applicable for the above-described wind turbine generator 100 comprising a support structure 120 including a tower 121, a nacelle 110 connected to the tower 121, and two or more blades 130 mounted on a hub 131 connected to the nacelle 110. The wind turbine generator 100 further comprises at least one oscillation damping arrangement 400 as herein described, which is arranged within at least one of the two or more blades 130.

In a first step 510 of the method, one or more common frequencies f_{common} of at least one coupled mode oscillation, which is a combination of oscillations of the support structure 120 and oscillations of at least one of the two or more blades 130, are determined. As explained above, these oscillations are caused by forces transferred through the support structure 120 at seismic activity 161 in the ground 160 where the support structure 120 is positioned. As explained above, the common frequencies f_{common} of the at least one coupled mode oscillation may be determined based on the first f_{structure_1st} and the second f_{structure_2nd} eigen frequencies of the support structure. The first f_{structure_1st} and the second f_{structure_2nd} eigen frequencies of the support structure may be determined by numerical analysis, e.g. specific eigen-value analysis, during the design process of the support structure.

In a second step 520 of the method, the at least one oscillation damping arrangement 400 is tuned to the one or more common frequencies f_{common} determined in the first step 510. Hereby, the at least one oscillation damping arrangement 400 is specifically adjusted to target the coupled mode oscillations caused by the seismic activity, whereby these oscillations are efficiently reduced in amplitude/power.

According to an aspect of the present invention, a method 600 for assembly of a wind turbine generator 100 is presented.

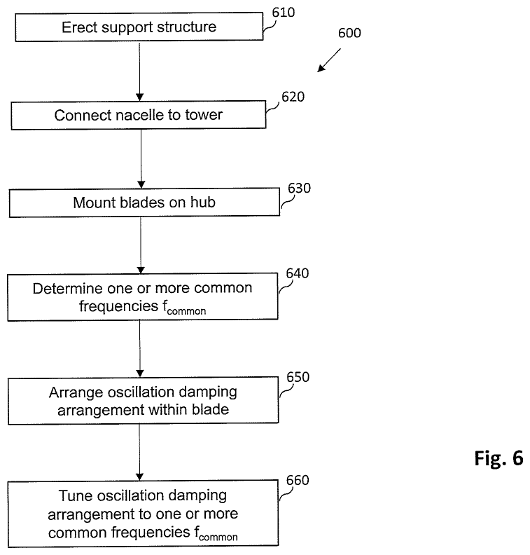

FIG. 6 shows a flow chart diagram for the method 600.

The method is applicable for the above-described wind turbine generator 100, which, when being assembled, comprises a support structure 120 including a tower 121, a nacelle 110 connected to the tower 121, and two or more blades 130 mounted on a hub 131 connected to the nacelle 110. The assembled wind turbine generator 100 further comprises at least one oscillation damping arrangement 400 as herein described, which is arranged within at least one of the two or more blades 130.

In a first step 610 of the method, the support structure 120 including the tower 121 is erected.

In a second step 620 of the method, the nacelle 110 is connected to the tower 121.

In a third step 630 of the method, the two or more blades 130 are mounted on the hub 131, which is connected to the nacelle 110.

In a fourth step 640 of the method, one or more common frequencies f_{common} of the at least one coupled mode oscillation are determined. As explained above, the least one coupled mode oscillation is a combination of oscillations of the support structure 120 and oscillations of at least one of the two or more blades 130, being caused by forces transferred through the support structure 120 at seismic activity 161 in the ground 160 where the support structure 120 is positioned.

In a fifth step 650 of the method, the at least one oscillation damping arrangement 400 is arranged within at least one of the two or more blades 130.

In a sixth step 660 of the method, the at least one oscillation damping arrangement 400 is tuned to the determined one or more common frequencies f_{common}, whereby the oscillations at these frequencies are efficiently reduced in amplitude/power.

It should be noted that the method steps illustrated in FIGS. 5-6, and described herein, do not necessarily have to be executed in the order illustrated in these figures. The steps may essentially be executed in any suitable order, as long as the physical requirements and the information needed to execute each step is available when the step is executed.

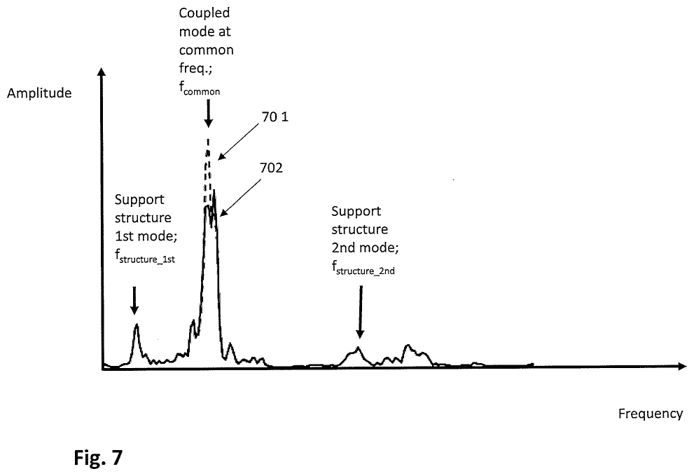

FIG. 7 illustrates the impact the present invention has on a tower load/moment. The figure shows the tower load/moment as a function of the frequency. The load/moment amplitude is highest at the frequency of the coupled mode oscillations f_{common}, which is located between the first eigen frequency (Support structure 1^{st} mode; f_{structure_1st}) and the second eigen frequency (Support structure 2^{nd} mode; f_{structure_2nd}) of the support structure, as explained above.

The amplitude of the tower load/moment for an undamped wind generator turbine, i.e. without any of the aspects or embodiments of the present invention implemented, is shown as a dashed curve 701. Also, the amplitude of the tower load/moment for a wind generator turbine with a liquid damper according to one of the herein described embodiments, which is tuned to the frequency of the coupled mode oscillations f_{common}, is shown as a solid curve 702 in the figure.

As seen in FIG. 7, the amplitude of the tower load/moment is considerably reduced at the critical coupled mode oscillation frequency f_{common}. This reduces the risk for damages and/or fatigue/wear on wind turbine generators, as explained above.

The present invention is not limited to the above-described embodiments. Instead, the present invention relates to, and encompasses all different embodiments being included within the scope of the independent claims.

1. A wind turbine generator (100) comprising:
a support structure including a tower;
a nacelle connected to the tower;
two or more blades mounted on a hub connected to the nacelle; and
at least one oscillation damping arrangement arranged within at least one of the two or more blades, the at least one oscillation damping arrangement being tuned to one or more common frequencies (f_{common}) of at least one coupled mode oscillation, such that the at least one coupled mode oscillation is mitigated by the at least one oscillation damping arrangement; wherein
the at least one coupled mode oscillation at the one or more common frequencies (f_{common}) is a combination of oscillations of the support structure and oscillations of at least one of the two or more blades; and
the oscillations of the support structure and the oscillations of the at least one of the two or more blades are caused by forces transferred through the support structure at seismic activity in the ground where the support structure is positioned.

2. The wind turbine generator as claimed in claim 1,
wherein the one or more common frequencies (f_{common}) of the at least one coupled mode oscillation comprise a frequency within a range between first (f_{structure_1st}) and second (f_{structure_2nd}) eigen frequencies of the support structure.

3. The wind turbine generator as claimed any one of in claim 1, wherein the at least one oscillation damping arrangement comprises a liquid damper including at least one liquid container.

4. The wind turbine generator as claimed in claim 3, wherein the liquid damper is tuned to the one or more common frequencies (f_{common}) of the at least one coupled mode oscillation by controlling a level of liquid in the container.

5. The wind turbine generator as claimed in claim 1, wherein the at least one oscillation damping arrangement comprises at least one mass element, at least one spring element and at least one damping element.

6. The wind turbine generator as claimed in claim 5, wherein the at least one oscillation damping arrangement comprises a friction spring damper.

7. The wind turbine generator as claimed in claim 6, wherein the friction spring damper is tuned to the one or more common frequencies (f_{common}) of the at least one coupled mode oscillation by adjustment of one or more in the group of:
a weight of the at least one mass element;
a spring constant of the at least one spring element; and
a damping effect of the least one damping element.

8. The wind turbine generator as claimed in claim 1, wherein the at least one oscillation damping arrangement comprises one or more in the group of:
at least one pendulum damper;
at least one eddy current damper; and
at least one hydraulic damper.

9. The wind turbine generator as claimed in claim 1, wherein the at least one oscillation damping arrangement is arranged closer to a tip of the blade than to a root of the blade.

10. The wind turbine generator as claimed in claim 1, wherein the at least one oscillation damping arrangement is arranged in a direction within a blade such that edgewise vibrations of the blade are mitigated.

11. The wind turbine generator as claimed in claim 1, wherein the support structure comprises a monopile foundation.

12. The wind turbine generator as claimed in claim 1, wherein the two or more blades have a length resulting in a rotor diameter (Dᵣₒₜₒᵣ) of at least 150 m for the wind turbine generator.

13. The wind turbine generator as claimed in claim 1, wherein the wind turbine generator is an offshore wind turbine generator.

14. (canceled)

15. An oscillation damping arrangement arranged within a blade of a wind turbine generator, the wind turbine generator comprising:
a support structure including a tower;
a nacelle connected to the tower; and
two or more blades mounted on a hub connected to the nacelle; wherein:
the at least one oscillation damping arrangement is tuned to one or more common frequencies (f_{common}) of at least one coupled mode oscillation, such that the at least one coupled mode oscillation is mitigated by the at least one oscillation damping arrangement;
the at least one coupled mode oscillation at the one or more common frequencies is a combination of oscillations of the support structure and oscillations of at least one of the two or more blades; and
the oscillations of the support structure and the oscillations of the at least one of the two or more blades are caused by forces transferred through the support structure at seismic activity in the ground where the support structure is positioned.

16. A blade of a wind turbine generator, the wind turbine generator comprising:
a support structure including a tower;
a nacelle connected to the tower; and
two or more blades mounted on a hub connected to the nacelle;
the blade comprising:
at least one oscillation damping arrangement being tuned to one or more common frequencies (f_{common}) of at least one coupled mode oscillation, such that the at least one coupled mode oscillation is mitigated by the at least one oscillation damping arrangement; wherein
the at least one coupled mode oscillation at the one or more common frequencies is a combination of oscillations of a support structure and oscillations of at least one of the two or more blades; and
the oscillations of the support structure and of the at least one of the two or more blades are caused by forces transferred through the support structure at seismic activity in the ground where the support structure is positioned.

17. A method for mitigating at least one coupled mode oscillation of a wind turbine generator, the wind turbine generator comprising:
a support structure including a tower;
a nacelle connected to the tower;
two or more blades mounted on a hub connected to the nacelle; and
at least one oscillation damping arrangement arranged within at least one of the two or more blades;
the method comprising:
determining one or more common frequencies (f_{common}) of at least one coupled mode oscillation being a combination of oscillations of the support structure and oscillations of at least one of the two or more blades, wherein the oscillations are caused by forces transferred through the support structure at seismic activity in the ground where the support structure is positioned; and
tuning the at least one oscillation damping arrangement to the determined one or more common frequencies (f_{common}).

18. A method for assembling a wind turbine generator, the method comprising:
erecting a support structure including a tower;
connecting a nacelle to the tower;
mounting two or more blades on a hub connected to the nacelle;
determining one or more common frequencies (f_{common}) of at least one coupled mode oscillation being a combination of oscillations of the support structure and oscillations of at least one of the two or more blades, wherein the oscillations are caused by forces transferred through the support structure at seismic activity in the ground where the support structure is positioned;
arranging at least one oscillation damping arrangement within at least one of the two or more blades; and
tuning the at least one oscillation damping arrangement to the determined one or more common frequencies (f_{common}).

19. A power plant configured to provide electric power to an electric power grid, wherein the power plant comprises a plurality of wind turbine generators; wherein at least one wind turbine generator of the plurality of wind turbine generators comprises:
a support structure including a tower;
a nacelle connected to the tower;
two or more blades mounted on a hub connected to the nacelle; and
at least one oscillation damping arrangement arranged within at least one of the two or more blades, the at least one oscillation damping arrangement being tuned to one or more common frequencies (f_{common}) of at least one coupled mode oscillation, such that the at least one coupled mode oscillation is mitigated by the at least one oscillation damping arrangement; wherein:
the at least one coupled mode oscillation at the one or more common frequencies (f_{common}) is a combination of oscillations of the support structure and oscillations of at least one of the two or more blades; and
the oscillations of the support structure and the oscillations of the at least one of the two or more blades are caused by forces transferred through the support structure at seismic activity in the ground where the support structure is positioned.
